(19) United States
(12) Patent Application Publication
(10) Pub. No.: US 2020/0123007 A1
(43) Pub. Date: Apr. 23, 2020

(54) ENRICHED SYNTHESIS OF SEMICONDUCTING NANOTUBES

(71) Applicant: Carbon Technology, Inc., San Clemente, CA (US)

(72) Inventors: Dawei Wang, Irvine, CA (US); Weiwei Zhou, Irvine, CA (US); Mark Chapman, Irvine, CA (US)

(21) Appl. No.: 16/661,506

(22) Filed: Oct. 23, 2019

Related U.S. Application Data
(60) Provisional application No. 62/749,588, filed on Oct. 23, 2018.

(51) Int. Cl. C01B 32/162; C01B 32/159

(52) U.S. Cl. CPC C01B 32/162; C01B 2202/36; C01B 32/159

(57) ABSTRACT

The present invention discloses compositions and methods for generating engineered catalysts and synthesizing semiconducting single wall carbon nanotubes using the catalysts Carbon nanotubes (CNTs). The CNTS are either metallic or semiconducting, with diameters controlled by an engineered catalyst to selectively synthesizes the semiconducting CNT. The engineered catalyst consists of two types of metals, a high melting point metal and an active transition metal. Each of the metals remains solid state during a growth of semiconducting CNTs, and each is present as nanoparticles, having sizes between 0.5 nm and 10 nm. The ratio of the high melting point metal with respect to the active transition metal is preferably between 1:0.25 and 1:10.

This application claims the benefit of priority to U.S. Provisional Application No. 62/749,588 filed Oct. 23, 2018. This and all other referenced extrinsic materials are incorporated herein by reference in their entirety.

This invention was made with government support under NSF Standard Grant 1632566 and 1417276, awarded by National Science Foundation. The government has certain rights in the invention.

### FIELD OF THE INVENTION

The field of the invention is compositions and methods for generating engineered catalysts and synthesizing semiconducting single wall carbon nanotubes using the catalysts.

### BACKGROUND

The following description includes information that may be useful in understanding the present invention. It is not an admission that any of the information provided herein is prior art or relevant to the presently claimed invention, or that any publication specifically or implicitly referenced is prior art.

Due to their superior electrical properties, carbon nanotubes (CNTs) are considered a potential building block for next generation high performance electronic devices. CNTs have great potential in numerous foreseeable applications. However, to create high performance Carbon Field Effect Transistors (CFETs) and take advantage of the significant advances in linearity they bring, high quality CNT material is needed. Recent studies show that selective growth of semiconducting CNT on Si substrate is possible and very high yields of semiconducting or CNTs have been obtained from chemical vapor deposition (CVD) growth. The crystal structure of the metal catalyst has been shown to play an important role in the selectivity. To fully exploit this phenomenon, employing a catalyst which remains solid state at growth temperature is the key. CNTs with a narrow diameter distribution could be synthesized using CVD processing techniques by using a monolayered and ordered catalyst matrix which would remain stable throughout CNT growth making the subsequent tubes amenable to selective etching. It is critical to produce evenly sized nanoparticles and to generate a monolayered and highly ordered matrix. The method of generating the matrix was described in publication “Block Copolymer Lithography by Boyd, David A., (2013), In: New and future developments in catalysis: catalysis by nanoparticles. Elsevier, Amsterdam, pp. 305-332. ISBN 978-0-444-53874-1”, in which is incorporated herein by reference in its entirely herein.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

It has been shown that creating a proper oxidative environment during growth can selectively etch away or inhibit the formation of metallic CNTs. This is likely due to metallic CNTs having a smaller ionization energy, thus being more amenable to etching than their semiconducting counterparts. Professor Jie Liu at Duke University, found that by introducing H₂O in the gas precursor, a higher yield of semiconducting CNTs can be obtained when employing CVD growth with an iron catalyst (General Rules for selective growth of enriched semiconducting single walled carbon nanotube with water vapor as in situ etchant, Zhou et al., J. Am. Chem. Soc., 2012, 134 (34), pp 14019-14026). A recently developed optical characterization technique confirms that the CNTs grown by the same group contain highly enriched semiconducting CNTs with diameters between 1.6 nm and 2.1 nm. However, the proper oxidative environment has not yet been established, nor has the proper combination of catalyst with oxidative environment.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for systems and methods for improving the quality of CNTs by narrowing the CNT's diameter size distribution and enhancing semiconducting CNT against metallic CNT.

### SUMMARY OF THE INVENTION

The inventive subject matter provides apparatus, systems and methods for generating the engineered catalysts, and synthesizing semiconducting single wall carbon nanotubes (SWCNTs) by use of the engineered catalyst.

Carbon nanotubes (CNTs) have great potential for high performance radio frequency (RF) applications. Linearity is the underlying limitation in increasing the data transport densities of wireless networks. The complex modulation protocols used to achieve ever higher data rates require linear amplifiers. Linearity also affects the fundamental performance of critical RF components such as mixers and amplifiers used in the most sensitive applications. Increasing linearity in current bulk semiconductors is achieved by driving higher currents through large transistor channels and limiting the RF operating region to the most linear portion of the depletion curve. This wastes power and generates heat while limiting performance. The intrinsic linearity of CNTs offers significant improvements in performance without sacrificing power and has the potential for greatly improving performance of RF devices.

CNT are either metallic or semiconducting and semiconducting CNT are capable of performing the function described above. In order to have more semiconducting CNT with respect to metallic CNT, the diameter of CNT needs to be controlled so that a growth condition favorable to semiconducting CNTs can be developed.

An engineered catalyst synthesizes tight distribution of CNT's diameter of less than 2.5 nm. The engineered catalyst consists of two types of metals, a high melting point metal and an active transition metal. The high melting point metal is part of a nanoparticle and preferably includes at least one of metals, rhodium(Rh), iridium(Ir), platinum(Pt), tungsten(W), and molybdenum(Mo).

The active transition metal is also part of a nanoparticle and preferably includes at least one of metals, cobalt, nickel, and iron. The active transition catalyst is thought to facilitate the growth of both semiconducting and metallic CNTs, thereby increasing the quantity of the CNTs. Since the high melting point metal maintains the size and composition of the catalyst by keeping it solid state during CNT synthesis and preventing re-aggregation due to Ostwald ripening from occurring, therefore, a combination of the high melting point metal and the active transition metal catalyst is thought to be especially considered. The ratio of the high melting point metal with respect to the active transition metal is preferably between 1:0.25 and 1:10.

The diameter of the catalyst nanoparticles including both the high melting point metal and the active transition metal is in the range of 0.5 and 10 nm. The range is preferably, between 1 and 5 nm and the most preferably 1.0 and 2.5 nm.

The CNT is synthesized using chemical vapor deposition. In order to accomplish the tight distribution of CNT's diameter, not only having the engineered catalyst, but it is also required to have a substrate where a monolayered and evenly spaced catalyst matrix coated on. The coating method is described in the publication referenced above. Therefore, preferred embodiments of CNT synthesis include a step of generating monolayered and evenly spaced catalyst matrix on a substrate using the engineered catalyst. The substrate includes a silicon wafer, a quartz wafer and an Al₂O₃ layer covered material.

Then, CNT is synthesized on the substrate at a temperature at least 800 Celsius in the presence of the gases including at least one of argon, hydrogen, and ethanol. As a result, CNT's diameter less than 2.5 nm can be synthesized including both metallic and semiconducting CNT. However, the CNT is synthesized in an oxidizing environment. The oxidizing environment inhibits nucleation and growth of metallic CNT, thereby reducing the synthesis of metallic CNT. The oxidizing environment is generated using at least one of the components including water introduced through a bubbler and oxide film, such as cerium oxide on substrate.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1: TEM images of Rh and Ir nanoparticles. Left: 5 nm Rh cube; Middle: Histogram plot of Rh particle size distribution; Right: 2 nm Ir nanoparticles.

FIG. 2: AFM image showing engineered catalyst particle size of around 1-2.5 nm.

FIG. 3: Left: AFM image of CNTs grown from the engineered catalyst; Right: Histogram plot of the CNT diameter distribution from the same sample

FIG. 4: Etching effect of water vapor during the growth process (Rh catalyst). SEM images of the SWCNTs grown with gas mixtures of EtOH(Ar):H₂O(Ar):H₂ at flow rate of (in sccm, “standard cubic centimeters per minute”) (a)(150:0:150-180:0:250) (b) (150:20:200-180:30:250) (c) (150:25:200-180:35:250), and (d) (150:40:200-180:45:250) for 45 min at 900° C.

FIG. 5: On/Off ratio data from CNT FET using CNTs grown from Rh and Ir catalyst. Left: CNT grown from Rh catalyst. 9 out of 12 devices show improved On/Off ratio. Insite: SEM image of a representative device; Right: CNT grown from Ir catalyst. 16 out 17 working devices on one test wafer show improved On/Off ratio. The red dashed lines at On/Off ratio equals to 3 are guide for eyes. Data points above this line indicate an improved On/Off ratio.

FIG. 6: Left: SEM image of synthesized CNTs on substrate; Right: Raman spectroscopy of the same sample showing that almost all NTs are semiconducting (Blue shaded area), indicating the selectivity of the growth.

FIG. 7: Data shows that a CFET with multiple CNTs in the channel can be turned off by applying gate voltage, indicating that all CNTs in the channel are semiconducting. Left: I_{DS}-V_{G} data, InSite: SEM image of the device; Right: I_{DS}-V_{DS}.

FIG. 8: More than 50 devices from two wafers grown from engineered catalyst show on/off ratio greater than 3(Green dashed line), indicating an enrichment of semiconducting CNTs from synthesis.

### DETAILED DESCRIPTION

### Experiments

Catalyst Selection

Metals with high melting point were selected as catalyst materials based on their unique physical properties of high melting temperature and low vapor pressure. Nano particles of these materials were synthesized using a chemical processing method. FIG. 1 shows the transmission electron microscopy images of nano particles whose sizes are 5 nm, and ˜2 nm respectively.

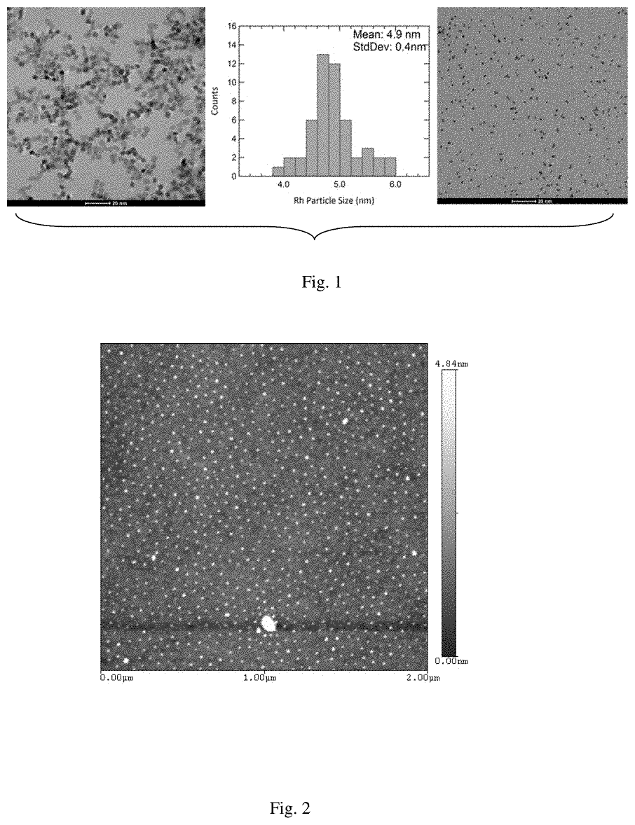

FIG. 2 shows the AFM images of the engineered catalyst. The nanoparticles have narrow size distribution. The representing data from the 5 nm Rh particles show their standard deviation is 0.4 nm.

CNTs Size Control

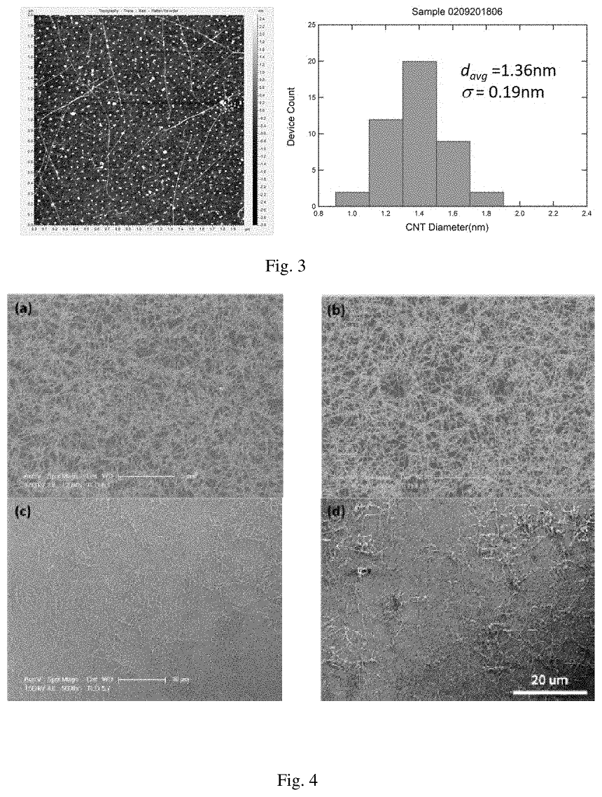

The diameters of the CNTs synthesized using all particles show very narrow size distribution. FIG. 3 shows the AFM image and histogram plot of the diameter distributions of CNTs synthesized using engineered catalyst. The synthesized CNTs have mean diameters of ˜1.36 nm and standard deviations of ˜0.19 nm.

H₂O Etching Effect on CNTs

A series of experiments have been carried out to understand the H₂O etching effect on CNTs, building on the pioneering work performed by our collaborator, Dr. Liu. In the experiment, H₂O vapor is introduced to a furnace through a bubbler using Argon (Ar) as the carrier gas. A strong H₂O etching effect on CNTs has been observed at both post growth treatment as well as for in-situ growth processes. It has been found that hydrogen gas (H₂) can be used to adjust the etching speed of the CNTs, and that the etching effect on these CNTs can be significantly slowed down when H₂ flow rate is increased. This is because H₂ is one of the products of the reaction. This gives us a better degree of control of the CNT etching during CVD synthesis, which better preserves the semiconducting parts and provides more control over the etching away (or inhibition of the formation) of metallic CNTs.

FIG. 4 shows the etching result during CNT growth with different flow rate of H₂O precursor. Ethanol is used as the carbon source through a bubbler using Ar as carrier gas (EtOH(Ar)) during the growth. Again, the H₂O etching effect on CNTs is clearly evidenced as a stronger etching effect is observed when H₂O flow rate is increased. We can therefore conclude that H₂O is a viable candidate for the effective etching of CNTs in situ.

Improved On/Off Ratio

Preferential growth of semiconducting CNTs has been observed using an engineered catalyst in H₂O environments. On/Off ratio is a metric to measure the semiconducting to metallic NT ratio. An On/Off ratio higher than 5, indicating a semiconducting to metallic CNT ratio of at least 4, is achieved as shown from various high melting point catalysts.

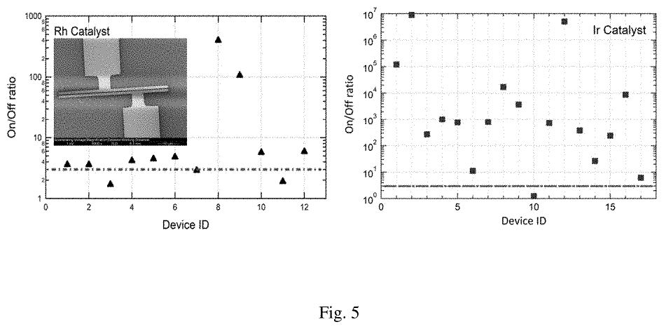

FIG. 5 shows the growth results from Rh and Ir catalysts. For Rh catalyst, 9 out of 12 devices have an On/Off ratio higher than 3, indicating preferential growth of semiconducting tubes. For CNTs grown from Ir nanoparticles (FIG. 5 right), 16 out of 17 devices show an improved On/Off ratio with a minimum On/Off ratio of 6 observed from the improved ratio. The Engineered Catalyst nanoparticles appear to work more efficiently in selectively growing semiconducting CNTs. This is thought to be because the nanoparticles are stable at synthesis temperatures while resisting re aggregation and Oswald ripening effects.

FIG. 6 shows the SEM image and Raman spectroscopy of CNTs grown from engineered catalyst. In the Raman plot, the peaks (if there is any) in the pink shaded areas are from metallic NTs, the peaks in the blue shades area are from semiconducting NTs. The data show almost no peaks from metallic NTs indicate there is a selectivity in synthesizing semiconducting NTs in this range.

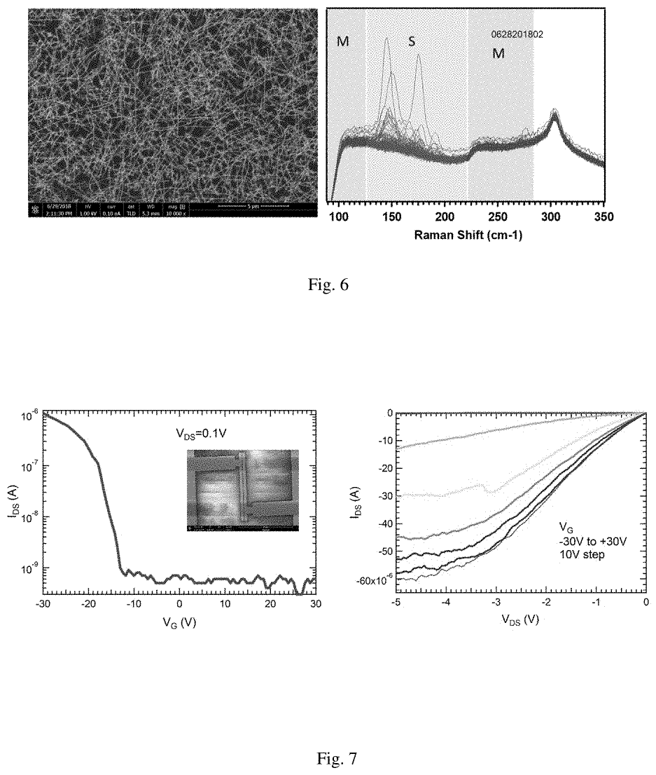

FIG. 7 shows the I-V data of a representing device built from CNTs synthesized from the engineered catalyst which has On/Off ratio greater than 1000. This indicate that there are no metallic NTs in the channel.

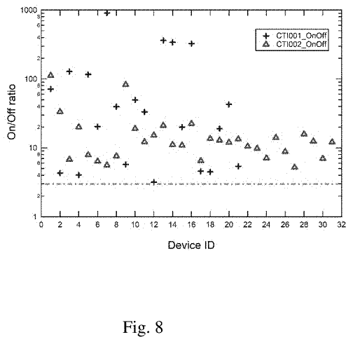

FIG. 8 shows the On/Off ratio of more than 50 devices from two wafers grown from engineered catalyst. Almost all devices showing On/Off ratio On/Off ratio greater than 3 indicates that selective growth of semiconducting CNTs is achieved using the catalyst and recipe developed herein.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An engineered catalyst for facilitating a selective growth of semiconducting carbon nanotubes, comprising;
a high melting point metal;
an active transition metal; and
wherein each of the high melting point metal and the active transition metal remains solid state during the selective growth, and are present as nanoparticles, having sizes between 0.5 nm and 10 nm, inclusive; and
wherein each of the high melting point and the active transition metals is present in a numerical ration of between 1:0.25 and 1:10, inclusive.

2. The engineered catalyst of claim 1, wherein the high melting point metal includes at least one of rhodium, iridium, platinum, tungsten, and Molybdenum.

3. The engineered catalyst of claim 1, wherein the active transition metal includes at least one of cobalt, nickel, and iron.

4. The engineered catalyst of claim 1, wherein the size of the nanoparticles is between 1 and 5 nm.

5. The engineered catalyst of claim 1, wherein the size of the nanoparticles is between 1.6 and 2.2 nm.

6. A method of synthesizing semiconducting single wall carbon nanotubes (SWCNTs) using chemical vapor deposition, comprising:
generating a catalyst matrix on a substrate using the engineered catalyst of claim 1;
applying a gas to the catalyst matrix at a temperature of at least 800 Celsius, effective to produce the SWCNTs with outer diameters less than 2.5 nm;
applying an oxidizing environment to the SWCNTs, effective to inhibit growth of metallic carbon nanotubes on the catalyst matrix.

7. The method of claim 6, wherein the substrate is selected from the group consisting of a silicon wafer, a quartz wafer, and an Al₂O₃ layer covered material.

8. The method of claim 6, wherein the oxidizing environment is generated using at least one of water and cerium oxide.

9. The method of claim 6, wherein the gas comprises at least one of argon, hydrogen, and ethanol.
